(19) United States
(12) Patent Application Publication
(10) Pub. No.: US 2025/0363487 A1
(43) Pub. Date: Nov. 27, 2025

(54) RAPID AUTO-RETRIEVAL OF ALIASES FOR INTERACTION

(71) Applicant: Visa International Service Association, San Francisco, CA (US)

(72) Inventors: Rajashree Guthe, San Francisco, CA (US); Sivaprakasam Gnanasekaran, Austin, TX (US); Uday Vashisht, Fremont, CA (US); Gwen D. Ma, Belmont, CA (US); Tanay Suhas Jayawant, Sunnyvale, CA (US); Jarkko Oskari Sevanto, Berkeley, CA (US)

(73) Assignee: Visa International Service Association, San Francisco, CA (US)

(21) Appl. No.: 19/282,649

(22) Filed: Jul. 28, 2025

Related U.S. Application Data
(63) Continuation-in-part of application No. PCT/US2024/048453, filed on Sep. 25, 2024.
(60) Provisional application No. 63/588,921, filed on Oct. 9, 2023.
(60) Provisional application No. 63/677,577, filed on Jul. 31, 2024.

(51) Int. Cl. G06Q 20/38; G06Q 20/10

(52) U.S. Cl. CPC G06Q 20/385; G06Q 20/108

(57) ABSTRACT

A method is disclosed. The method includes receiving, by a server computer from a user device comprising a transfer application via a communications network, contact data for a plurality of potential users on the user device. The method also includes searching, by the server computer a database, for a set of aliases associated with the potential users in the contact data. The method also includes providing, by the server computer via the communications network, the set of aliases to the user device. The user device is programmed to store the set of aliases in the transfer application, receive a selection of an alias associated with a user, and initiate an interaction with the alias using the transfer application.

### CROSS-REFERENCE TO RELATED APPLICATIONS

This application is a continuation-in-part application of PCT/US2024/048453, filed on Sep. 25, 2024, which claims priority to U.S. Provisional Application No. 63/588,821, filed on Oct. 9, 2023. This application also claims priority to U.S. Provisional Application No. 63/677,577, filed on Jul. 31, 2024. All of the above application are herein incorporated by reference in their entirety.

### BACKGROUND

Some interaction processes allow different users to interact using different transfer applications managed by different entities. Transfer applications can be used to transfer data, funds, and other items. However, the individual users associated with each transfer application can number in the hundreds of thousands or millions. While the alias identifiers (e.g., usernames) of the users associated with the different users can be stored in a single database, it is difficult and time consuming to search the many hundreds of thousands or millions of alias identifiers each time a user wishes to use their transfer application to conduct a transfer with another user using a different transfer application.

Embodiments of the invention address these and other problems, individually and collectively.

### SUMMARY

Embodiments of the improve the speed of data processing in an interaction involving a user and a transfer application.

One embodiment of the invention includes a method comprising: receiving, by a server computer from a user device comprising a transfer application via a communications network, contact data for a plurality of potential users on the user device; searching, by the server computer a database, for a set of aliases associated with the potential users in the contact data; and providing, by the server computer via the communications network, the set of aliases to the user device, wherein the user device is programmed to store the set of aliases in the transfer application, receive a selection of an alias associated with a user, and initiate an interaction with the alias using the transfer application.

Another embodiment includes a server computer comprising: a processor; and a computer readable medium, the computer readable medium comprising code, executable by the processor for performing a method comprising: receiving, from a user device comprising a transfer application via a communications network, contact data for a plurality of potential users on the user device; searching a database for a set of aliases associated with the potential users in the contact data; and providing, via the communications network, the set of aliases to the user device, wherein the user device is programmed to store the set of aliases in the transfer application, receive a selection of an alias associated with a user, and initiate an interaction with the alias using the transfer application.

Another embodiment includes a method comprising: transmitting, by a user device comprising a transfer application to a server computer via a communications network, contact data for a plurality of potential users on the user device, wherein the server computer searches a database, for a set of aliases associated with the potential users in the contact data; and receiving, by user device from the server computer via the communications network, the set of aliases; storing, by the user device, the set of aliases in the transfer application; and receiving, by the user device, a selection of an alias associated with a user; and initiating, by the user device, an interaction with the alias using the transfer application.

Another embodiment of the invention includes a user device comprising a processor; and a computer readable medium comprising a transfer application. The computer readable medium comprises code, executable by the processor, for performing a method. The method comprises transmitting, by the user device comprising a transfer application to a server computer via a communications network, contact data for a plurality of potential users on the user device, wherein the server computer searches a database, for a set of aliases associated with the potential users in the contact data; and receiving, by user device from the server computer via the communications network, the set of aliases; storing, by the user device, the set of aliases in the transfer application; and receiving, by the user device, a selection of an alias associated with a user; and initiating, by the user device, an interaction with the alias using the transfer application

These and other embodiments of the invention are described in further detail below.

### BRIEF DESCRIPTION OF THE DRAWINGS

FIG. 1 shows a transaction processing system using a receiver alias search according to embodiments.

FIG. 2 shows a system and a method for creating an alias and updating a database according to embodiments.

FIG. 3 shows a flow diagram of an auto-alias retrieval method according to embodiments.

FIGS. 4A-4B show exemplary user interfaces of a transfer application on a user device when a sender initiates a payment to a receiver.

FIG. 5 shows a system and method for a transaction between a sender and a receiver using a receiver alias.

FIG. 6 shows a block diagram of a user device according to embodiments.

FIG. 7 shows a block diagram of a server computer according to embodiments.

FIG. 8 shows example user interfaces showing the use of a photograph to authenticate a receiver in a transfer transaction.

### DETAILED DESCRIPTION

Before discussing embodiments of the invention, some description of some terms may be helpful.

“Account information” may include any suitable information associated with an account (e.g., a personal account number and/or payment device associated with the account). Such information may be related to the account or may be derived from information related to the account. Examples of account information may include a PAN (primary account number or “account number”), username, expiration date, and verification values such as CVV, dCVV, CVV2, dCVV2, and CVC3 values.

An “alias” may be nickname associated with a real identifier. An alias can be a phone number, e-mail address, username, etc. associated with a user's real name (e.g., John Smith). An alias can have any suitable number of type of characters. An alias can be used to conduct transfers instead of sensitive information. This preserves privacy and data security.

A “user” may include an individual. In some embodiments, a user may be associated with one or more personal accounts and/or mobile devices. The user may also be referred to as a cardholder, account holder, or consumer in some embodiments.

An “authorizing entity” may be an entity that authorizes a request. Examples of an authorizing entity may be an issuer, a governmental agency, a document repository, an access administrator, etc.

An “issuer” may typically refer to a business entity (e.g., a bank) that maintains an account for a user. An issuer may also issue payment credentials stored on a user device, such as a cellular telephone, smart card, tablet, or laptop to the consumer.

A “digital wallet provider” may refer to any entity, such as an issuing bank or third party service provider, which issues a digital wallet to a user that enables the user to conduct financial transactions. A digital wallet provider may provide standalone user-facing software applications that store account numbers, or representations of the account numbers (e.g., payment tokens), on behalf of a cardholder (or other user) to facilitate payments at more than one unrelated merchant, perform person-to-person payments, or load financial value into the digital wallet. A digital wallet provider may enable a user to access its account via a personal computer, mobile device, or POS device. Additionally, a digital wallet provider may also provide one or more of the following functions: storing multiple payment cards and other payment products on behalf of a user, storing other information including billing address, shipping addresses, and transaction history, initiating a transaction by one or more methods, such as providing a user name and password, NFC or a physical token, and may facilitate pass-through or two-step transactions. In some implementations, a user's issuing bank may be the digital wallet provider. Alternatively, the digital wallet provider may be a third party entity.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

A “transfer application” can include an application facilitating the transfer of funds between multiple parties. For instance, a transfer application can include a peer-to-peer transaction application. The transfer application can be executed on a mobile device associated with a user, and the transfer application can be implemented using a server (e.g., an application server) in communication with the mobile device. The transfer application can provide an account (e.g., from a digital wallet which may be part of the transfer application or external to it) for each user. The transfer application can allow a user to select a recipient user to transfer a specified amount of funds to the recipient user. The transfer application can then transfer the specified amount from an account for the user to an account for the recipient user.

An “application server” can be a server computer that is specifically designed to run applications. For instance, an application server can perform processing tasks relating to the above-described transfer application, such as provide user account details to be displayed on the transfer application executing on the mobile device or facilitate transfer of funds between users on the transfer application.

A “token” may be a substitute value for a credential. A token may be a string of numbers, letters, or any other suitable characters. Examples of tokens include payment tokens, access tokens, personal identification tokens, etc.

A “push transfer message” can include a message that causes value (e.g., funds) to be pushed from one entity to another. In some embodiments, for example, a push transaction message can be generated by the application server to initiate a transaction between a sender and a receiver to push funds to the receiver. In a push transaction, the intended recipient of the funds does not first initiate the funds transfer messaging. The push transfer message can include user account details, a credential (identified from the receiver alias) relating to the receiver, and a transaction amount. In some instances, the push transfer message can comprise an original credit transaction (OCT) format.

Embodiments of the invention can include the use of a new inquiry API designed to greatly increase discoverability. Transfer application server computers (e.g., wallet server computers) that use this API can have the ability to send contact data in the form of a list of contacts (names of people with their phone numbers, e-mail addresses, etc.) from a user's device to a server computer. The server computer can use the contact data to perform a search for aliases (e.g., pay names) in a database. The aliases may be linked to access data such as credentials (e.g., primary account numbers such as credit or debit card account numbers, or tokens thereof). The inquiry API then responds and provides a list of matching aliases to the user device. This allows users to effortlessly finding and recognizing other active aliases (e.g., Visa+ paynames) within their contact list for immediate interaction initiation (e.g., payment initiation). Each transfer application server computer can decide if they wish to turn on this function, or not turn on this function.

In embodiments of the invention, transfer application servers can submit an array of email addresses or phone numbers from a user's mobile address book. The server computer returns the list of aliases (e.g., Visa+ paynames) that match to the phone numbers or email addresses. If there is “no match,” nothing is returned. In some embodiments, 1-100 phone numbers and 1-100 emails can be sent in one API call. Users can view their alias (e.g., Visa+) ready contacts within their transfer application (e.g., wallet application).

Some embodiments of the invention may also relate to cross wallet payment methods and systems. For example, in a cross wallet payment, a sender may use a first transfer application on a user device to debit funds from their sender account and send them to a receiver account associated with a receiver, even if the sender account and receiver account are managed by different entities (e.g., first and second service providers such as first and second digital wallets). To initiate the cross wallet payment, the sender inputs a receiver alias associated with the receiver account (e.g., +amiller.paymo) associated with a second transfer application into a first transfer application along with an amount to transfer to a receiver record (e.g., a receiver account) the receiver. The receiver alias may be in a set of aliases that was retrieved from a set of aliases. The set of aliases may have been retrieved by the first transfer application from a contact list in another software application on the user device.

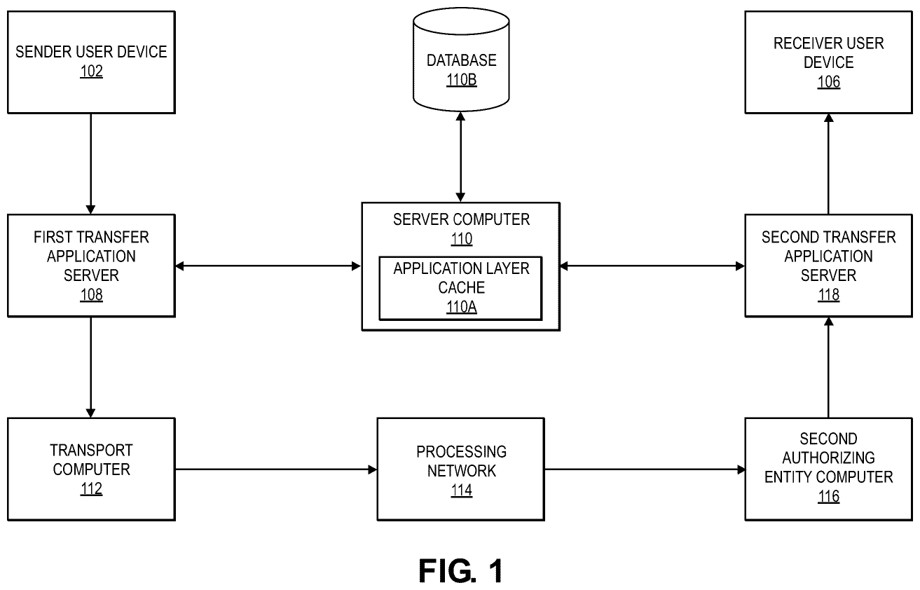

FIG. 1 shows a system according to embodiments. Using the system, a sender can conduct a transaction (e.g., sending a payment) using a first transfer application on a sender user device 102. The receiver can receive the payment using a second transfer application on a receiver user device 106.

The first transfer application and the second transfer application may each be a digital wallet application, a peer-to-peer payment application, etc., and use receiver aliases to identify and manage receiver user accounts. The first transfer application may be associated with a first transfer application server 108 that facilitates the functions of the first transfer application. The second transfer application may be associated with a second transfer application server 118 that facilitates the functions of the second transfer application. For example, the first transfer application server 108 may be a server computer for a first transfer application that enable senders to initiate payments to receivers using receiver aliases.

The first transfer application server 108 may also be in operative communication with a second authorizing entity computer 116 associated with the receiver of the receiver user device 106, via a transport computer 112 and a processing network 114. The second authorizing entity computer 116 may also maintain an account associated with the receiver which may be indicated by the virtual credential. A first authorizing entity computer (not shown) may hold an account of the sender of the sender user device 102 and may be in communication with the transport computer 112.

The first transfer application server 108 and the second transfer application server 118 may be operated by different entities, and may separately store and manage account information and aliases for its enrolled users. The first transfer application server 108 and the second transfer application server 118 can be in communication with a server computer 110 via one or more APIs.

The server computer 110 can comprise an application layer cache 110A which stores aliases from recent alias searches using contact data. The application layer cache 110A may store temporarily store aliases, and in some embodiments, can be periodically purged (e.g., once per day, week, month, or year) to allow the application layer cache 110A to retain its storage capacity. When a search request using contact data is conducted for an aliases, the server computer 110 retrieve search results from the database 110B and can store the search results in the application layer cache 110A. In some embodiments, the application layer cache 110A is not needed. This can be the case when the aliases retrieved using the contact data are sent to the first transfer application server 108 and are stored therein.

Database 110B may be a central database storing all aliases from the first transfer application server 108, the second transfer application server 118, and other transfer application servers (not shown). Database 110B enables a sender to search the receiver aliases of different transfer application servers using a single search request. The first transfer application server 108 and the second transfer application server 118 may each synchronize alias information to database 110B via the server computer 110. In some embodiments, the database 110B may be an elastic search database which enables regular synchronization of alias information with transfer application servers. For example, when a receiver enrolls a receiver alias with a second transfer application (not shown in FIG. 1), the second transfer application server 118 may submit a request to add the new receiver alias to the database 110B to the server computer 110.

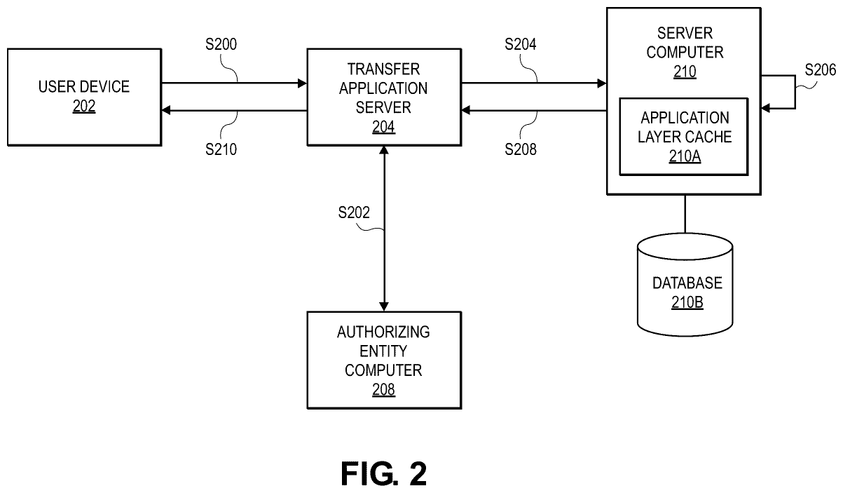

FIG. 2 shows a system and a method for creating an alias and updating a database with the alias according to embodiments. FIG. 2 shows a user device 202, a transfer application server 204, a server computer 210, and a database 210B. In FIG. 2, the user device 202 may be similar to the receiver user device 106 in FIG. 1, the server computer 210 may be similar to the server computer 110 in FIG. 1, the transfer application server 204 in FIG. 2 may be similar to the second transfer application server 118 in FIG. 1, and the authorizing entity computer 208 may be similar to the second authorizing entity computer 116 in FIG. 1.

A user can enroll with the transfer application server 204 using user device 202. For example, user device 202 may have a downloaded transfer application which enables communication between the user device 202 and the transfer application server 204. The server computer 210 may be in communication with the transfer application server 204 and database 210B.

The method stores aliases such as receiver aliases in the database 210B along with other enrollment information. Enrollment information can include a name of the user, an account number for an account to be used to send or receive transfers, the receiver alias, a transfer application identifier, etc.

At step S200, the user device 202 may request an alias from the transfer application server 204 using the transfer application. For example, the user may submit enrollment information the transfer application on the user device 202, and the user device 202 may transmit the receiver alias request to the transfer application server 204. Enrollment information may include the user's name, account number, and desired receiver alias.

At step S202, upon receiving the request for the alias, in some embodiments, the transfer application server 204 may issue a virtual credential that may link with the user account via an associated authorizing entity computer 208. The authorizing entity computer 208 may create and return the virtual credential to the transfer application server 204. The authorizing entity computer 208 may also maintain an account associated with the user which may be indicated by the virtual credential. The virtual credential may be in the form of a real payment credential, but unlike a real payment credential, it cannot be used to independently conduct payment transactions. The credential that will be issued can be a virtual receive only credential (i.e., a credential that only support incoming payments), or the credential can be a fully functional payment credential that can also be used in purchase transactions, AFTs, etc. In other embodiments, the receiver alias can be linked to a real credential (e.g., a real payment credential) instead of a virtual credential, or a tokenized version of the real credential or the virtual credential.

In step S204, the transfer application server 204 may submit a request to the server computer 210 to create an alias associated with the user. The request may comprise the alias chosen by the user in step S200, and the virtual credential (or real credential) issued by the authorizing entity computer 208 in step S202. Additionally, the request may contain the information related to the user account (e.g., a phone number associated with the user).

In step S206, the server computer 210 may receive the request to create an alias. The server computer 210 may retrieve the alias and the virtual credential from the request. Upon verifying the uniqueness of the alias from a database storing previously received requests (e.g., searching the database 110B of aliases to ensure that the requested alias does not overlap with plurality of aliases stored), the server computer 210 may optionally tokenize the virtual credential. After tokenizing the virtual credential, the server computer 210 may store the alias, the tokenized virtual credential, the virtual credential, and the user account information in the database 210B. The server computer 210 may also approve use of the alias.

In other embodiments, instead of using the authorizing entity computer 208 creating a virtual credential and the server computer 210 creating a tokenized virtual credential, the authorizing entity computer 208 can obtain other types of access data such as real credentials (e.g., primary account numbers) or tokens of real credentials, and can provide them to the server computer 210.

In some embodiments, if a virtual credential is obtained, the virtual credential can be a receive only credential. This can be used to add a layer of security when the token is used by a payment originator to initiate an OCT message. If the token is compromised by a third-party, the third-party will be unable to pull funds from the underlying account.

In step S208, the server computer 210 may confirm the approval of the alias with the transfer application server 204.

In step S210, the transfer application server 204 may notify the transfer application of the user device 202 that the alias was approved and is available for use. The virtual credential linked to the alias may point to the user account managed by the transfer application server 204. In some embodiments, the alias may be linked to both the virtual credential and the user account of the transfer application server 204.

The alias linked to a virtual credential may be used in a peer-to-peer transaction. For example, a sender using a first transfer application may send, receive, or request a transaction with a receiver using a second transfer application. The receiver alias allows for the transaction to be initiated. The receiver alias can then be resolved into a virtual credential that is linked to an account managed by the transfer application of the receiver.

Once the receiver is enrolled, the receiver alias is stored with other aliases in the database 210B. The aliases in the database 210B can be used to conduct transfer transactions.

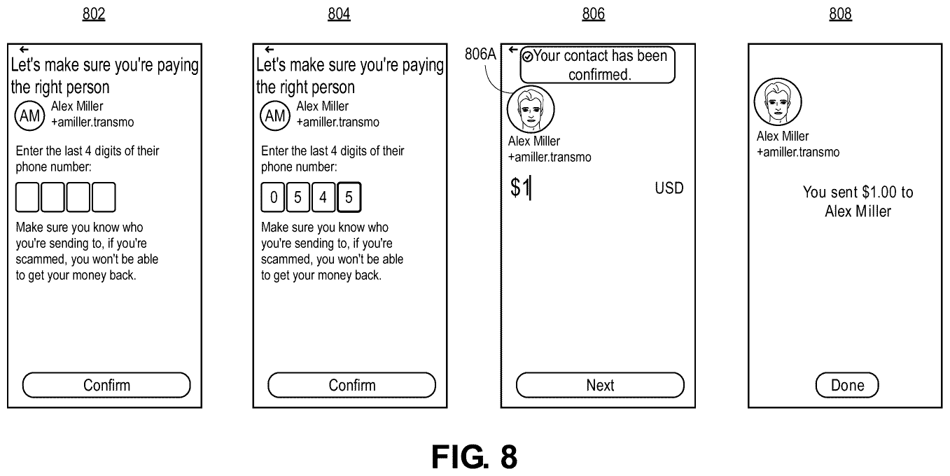

In some embodiments, the receiver may submit a photograph of the receiver to the transfer application server 204 and the server computer 210. The photograph can be used as an additional authentication mechanism to ensure that the sender is transferring funds to the correct, intended receiver. The use of the photograph is shown in FIG. 8, which is discussed below.

When the receiver submits the photograph to the server computer 210 via the transfer application server 204, it may be in the form of an image file such as a JPEG, PNG, PDF, or other type of image file. In some cases, the transfer application server 204 may already have a photograph of the receiver. In some embodiments, the photograph is converted from the image file to a base 64 string format and is submitted from the transfer application server 204 to the server computer 210 via an API. The server computer 210 can decide the base 64 string format into a binary format and can validate file type and size. It can then scan the binary data of the photograph for malware, viruses, etc. Once the validation is complete, the image can be stored in the database 210B.

Additional methods according to embodiments of the invention can be described with reference to FIGS. 1, 3, and 4.

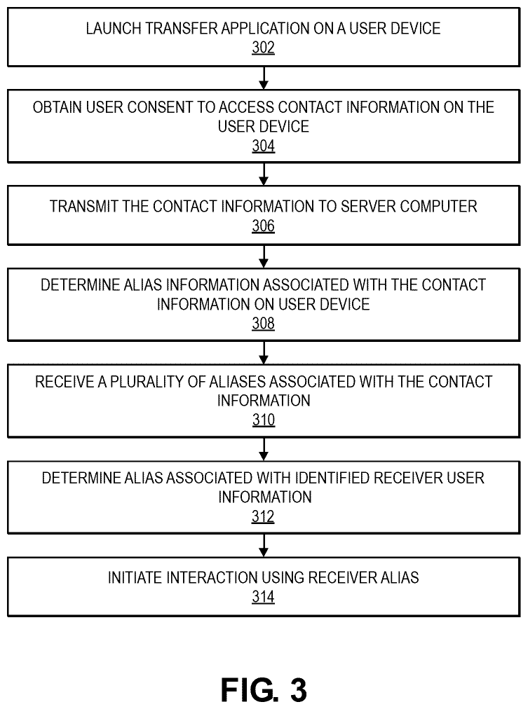

FIG. 3 shows a flow diagram for loading aliases in a transfer application on the user device using a contact list in a separate software application on the user device.

In step 302, a sender user operating the sender user device 102 can launch a first transfer application on the sender user device 102. The first transfer application may be a first wallet application.

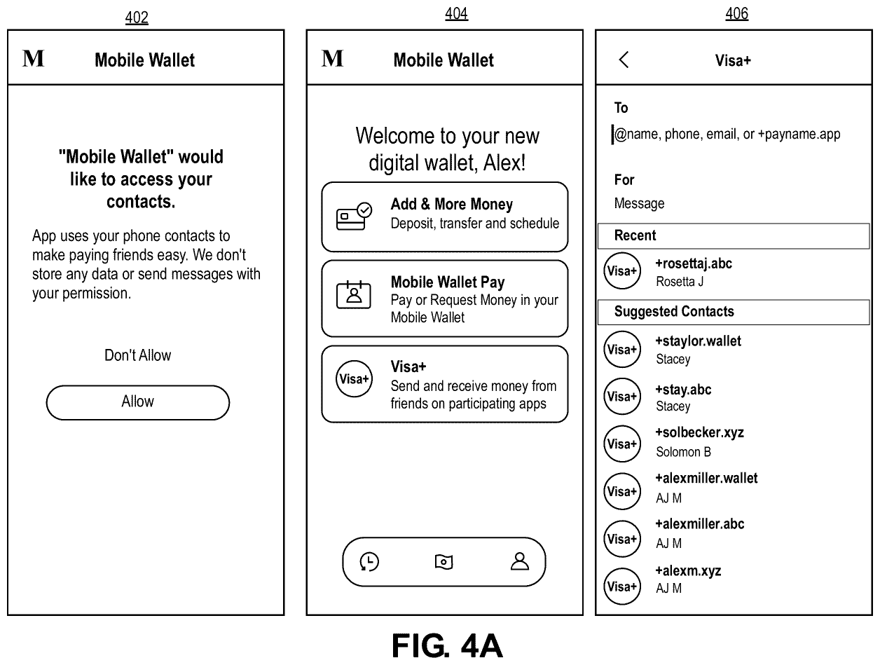

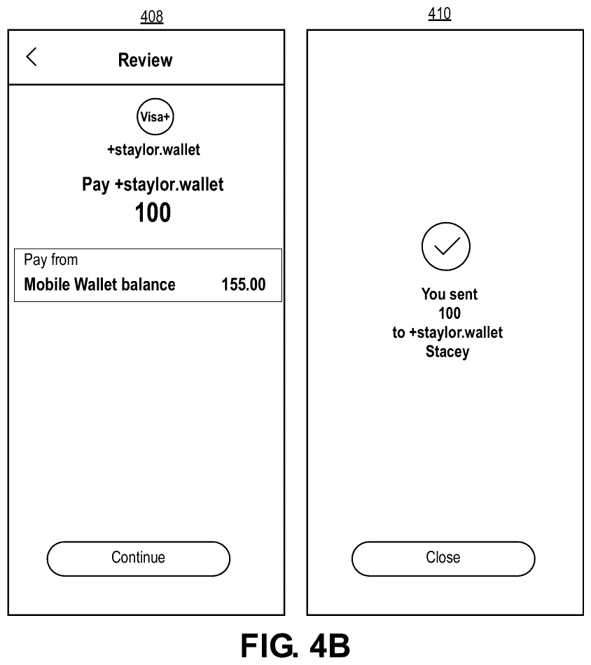

In step 304, upon launching the first transfer application, the first transfer application may obtain the sender user's consent to access contact data on the sender user device 102. This is shown in user interface 402 in FIG. 4A. The contact data may include a contracts list may be managed by a separate software application such as Microsoft Outlook™. The information may include users' names, phone numbers and e-mail addresses. The first transfer application and the first transfer application server 108 may access the contact data in the separate software application using an appropriate API (application programming interface) associated with the separate software application.

In step 306, the sender user device 102 can send to server computer 110 via the first transfer application server 108 over a communications network, the contact data.

In step 308, the server computer 110 search a database, for a set of aliases associated with the potential users in the contact data For example, the server computer 110 can use the phone numbers and/or e-mail addresses of users in the contact data, and determine if they are associated with users that have previously registered with the server computer 110. If so, the server computer can determine the aliases associated with the information.

While the set of aliases are being retrieved by the server computer 110, a list of interaction options can be presented to the sender user via the first transfer application as shown in user interface 404 in FIG. 4A. One option includes a process of transfer a value (e.g., an amount of money) from a sender record (e.g., a receiver account to a receiver record (e.g., a receiver account). An example of this type of process may be a person to person payment.

In step 310, before or after the sender user reviews the various interaction options and selects one of them, the server computer 110 can provide the set of aliases corresponding to the contact data on the sender user device 102 to the first transfer application on the sender user device 102. The set of aliases may be presented along with information identifying the users associated with this aliases as “suggested contacts” in the first transfer application on the sender user device 102 as shown in user interface 406 in FIG. 4A. The set of aliases may be stored at the application server 508 and/or the first transfer application in the sender user device 102, so that the sender user is presented with a list of potential receiver users in their contact data along with identifying information (e.g., their names) and their aliases. The sender user device 102 can be programmed to store the set of aliases in the first transfer application, receive a selection of an alias associated with a receiver user, and initiate an interaction with the receiver alias using the transfer application.

After step 312, the sender users select a receiver alias from the set of aliases to conduct the requested interaction (e.g., send money, receive money, conduct a payment transaction, etc.).

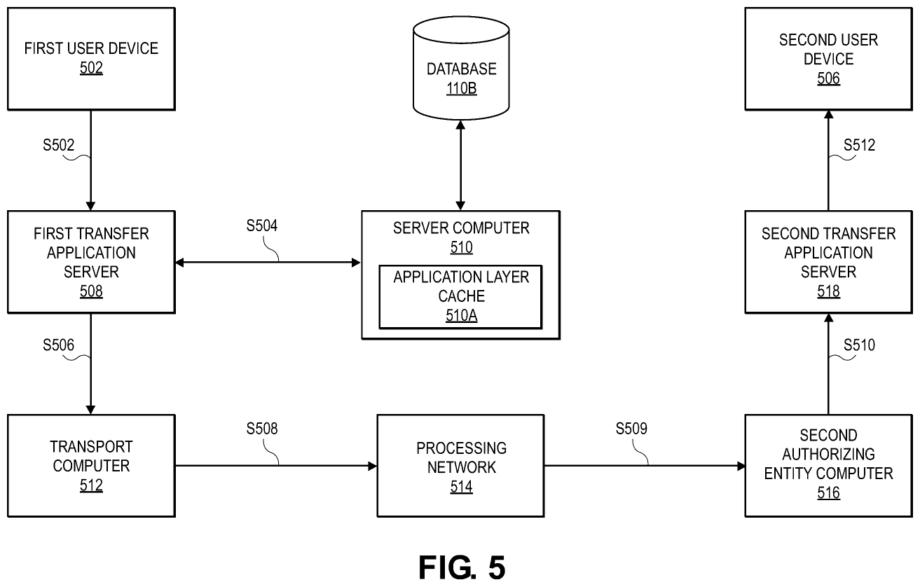

In step 314, an interaction is initiated between the sender user and the receiver associated with the selected alias. For example, FIG. 4B shows exemplary user interfaces 408, 410 of the first transfer application on the sender user device 102 when a sender initiates a transfer of funds to a receiver (“+staylor.wallet). In some embodiments, the interaction can include a push transfer involving an OCT (original credit transaction) message. An example of such an interaction (e.g., a payment transaction) can be described with reference to FIG. 5.

FIG. 5 shows a system 500 and method for a transaction between a sender and a receiver using a receiver alias. The entities in system 500 can be similar to the entities in system 100 of FIG. 1, and their descriptions will not be repeated here. In the method, a sender initiates a subsequent payment to a receiver. For example, the sender may have previously searched for the receiver alias using a set of characters as described in steps 302, 304, and 306 of FIG. 3 above. The set of characters and a set of aliases which match the set of characters may be cached in the application layer cache 110A, as described in step 308 of FIG. 3.

At step S502, the sender user device 102 transmits a receiver alias to the first transfer application server 108 via the first transfer application. For example, the sender user device 102 may receive a set of aliases after providing contact data to the server computer 110 as described above. The sender can use the first transfer application on the sender user device 102 to select an alias, and the selection may be transmitted from the sender user device 102 to the first transfer application server 108.

In step S504, the first transfer application server 508 may send the receiver alias to the server computer 510 to resolve the receiver alias into access data linked to the receiver user device 506. The server computer 510 may then retrieve the access data (e.g., a real credential, a tokenized real credential, a virtual credential, or a tokenized virtual credential stored by the server computer 210) from the database 110B and return the access data to the first transfer application server 508.

In step S506, after receiving the access data from the server computer 510, the first transfer application server 508, in conjunction with a transport computer 512, may generate a push transfer message. In some embodiments, the push transfer message may be an original credit transaction (OCT) message, and the access data may comprise the virtual credential. The OCT message comprise the amount of the transaction, an account identifier (or token) associated with the sender user device 502, and the virtual credential linked to the receiver alias of the receiver associated with the receiver user device 506. The OCT message may be sent to a second authorizing entity computer 516 via a processing network 514.

An OCT (Original Credit Transaction) can be a clearing and settlement credit transaction designed for use in business applications such as a business money transfer or business-to-consumer repayments. The OCT can be a transaction used to deliver funds to the recipient account. It is separate from, and can take place after, an AFT transaction in some cases. This timing is to ensure that payment funds are secured before funds are sent to the recipient.

In steps S508 and S509, after receiving the push transfer message from the first transfer application server 508, the transport computer 512 may route the push transfer message to a second authorizing entity computer 516 via a processing network 514.

In step S510, the second transfer application server 518 may receive the payment and deposit the funds into the account associated with virtual credential, or a real credential associated with the virtual credential. Alternatively, the second authorizing entity computer 516 could deposit the funds into the account associated with virtual credential, or a real credential associated with the virtual credential. The second authorizing entity computer 516 may have previously issued the virtual credential based on the real credential associated with the receiver.

In step S512, the second transfer application server 518 may notify the second transfer application of the receiver user device 506 on the received payment. The second transfer application may display a notification to the receiver on the completion of the transaction.

In some embodiments, the OCT message may comprise a tokenized real credential or a tokenized virtual credential instead of the virtual credential. In this case, the tokenized real credential or the tokenized virtual credential can be detokenized at a token service computer at the processing network 514 to obtain the real credential or the virtual credential. The token service computer may have a token vault which maps tokenized real credentials to real credentials and/or tokenized virtual credentials to virtual credentials. In yet other embodiments, the OCT message may contain the real credential (e.g., a real primary account number).

At a later time, actual funds associated with the transaction may be transferred from the first authorizing entity operating the first authorizing entity computer (not shown) coupled to the transport computer 512 to the second authorizing entity computer 516 via the processing network 514 along with funds from other transfers in a settlement process.

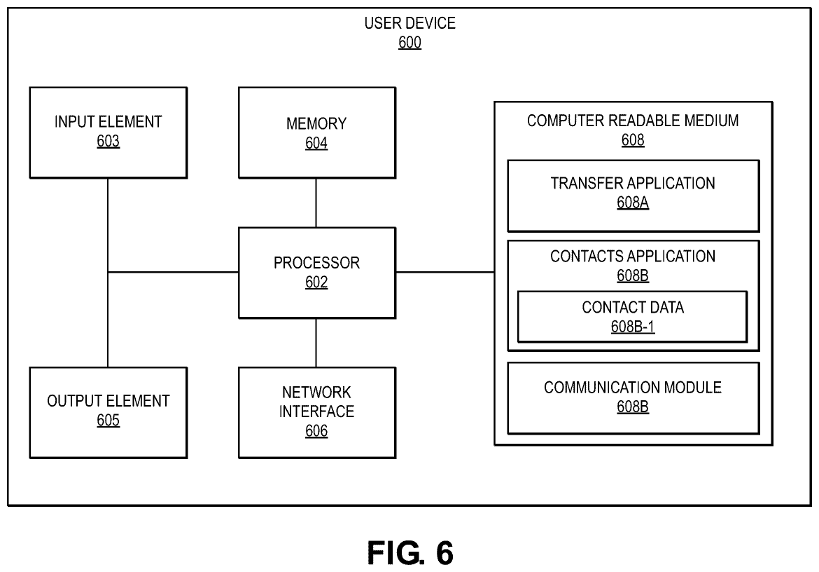

FIG. 6 shows a block diagram of a user device 600 according to embodiments. The user device 600 may comprise a processor 602. The processor 602 may be coupled to an input element 603, an output element 605, a memory 604, a network interface 606, and a computer readable medium 608. The computer readable medium 608 may comprise any suitable number and types of software modules.

Examples of input elements may include microphones, keypads, touchscreens, sensors, etc. Examples of output elements may include speakers, display screens, and tactile devices. The processor 602 can be implemented as one or more integrated circuits (e.g., one or more single core or multicore microprocessors and/or microcontrollers) and can be used to control the operation of the user device 600. The processor 602 can execute a variety of programs in response to program code or computer-readable code and can maintain multiple concurrently executing programs or processes.

The memory 604 may be used to store data and code. The memory 604 may be coupled to the processor 602 internally or externally (e.g., via cloud-based data storage), and may comprise any combination of volatile and/or non-volatile memory such as RAM, DRAM, ROM, flash, or any other suitable memory device. In some embodiments, the memory 604 may store the data items of a payload.

The network interface 606 may include an interface that can allow the user device 600 to communicate with external computers. The network interface 606 may enable the user device 600 to communicate data to and from another device such as an aggregation entity computer, a server computer, a transport computer, an authorizing entity computer, etc. Some examples of the network interface 606 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 606 may include Wi-Fi™. Data transferred via the network interface 606 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 606 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

The computer readable medium 608 may comprise code, executable by the processor 602, for a method comprising: transmitting, by a user device comprising a transfer application to a server computer via a communications network, contact data for a plurality of potential receivers on the user device, wherein the server computer searches a database, for a set of aliases associated with the potential receivers in the contact data; receiving, by user device from the server computer via the communications network, the set of aliases; storing, by the user device, the set of aliases in the transfer application; and receiving, by the user device, a selection of an alias associated with a receiver; and initiating, by the user device, an interaction with the alias using the transfer application.

The computer readable medium 608 may comprise several software modules including, but not limited to, a transfer application 608A, a contacts application 608B, and a communication module 608C.

The transfer application 608A may enable communication with a transfer application server. The transfer application 608A may include instructions or code implementing a transfer application 608A for initiating a transfer of funds to a recipient user device. The transfer application 608A may also include code, executable by the processor 602, for obtaining a transfer amount and receiver account identifier (e.g., by resolving a receiver alias to a receiver credential), providing the transfer amount and receiver account identifier to a transport computer, and/or forwarding a push transfer message to the processing network computer.

The contacts application 608B may store contact data 608B-1 such as phone numbers, names, addresses, etc. The contacts application 608B can be any suitable application which may contact data, including digital wallets, e-mail applications, social media applications, etc.

The communication module 608C may comprise code that causes the processor 602 to generate messages, forward messages, receive message, reformat messages, and/or otherwise communicate with other entities. In some embodiments, the communication module 608C may facilitate push transfer message and/or a pull transfer message being transmitted to a transport computer.

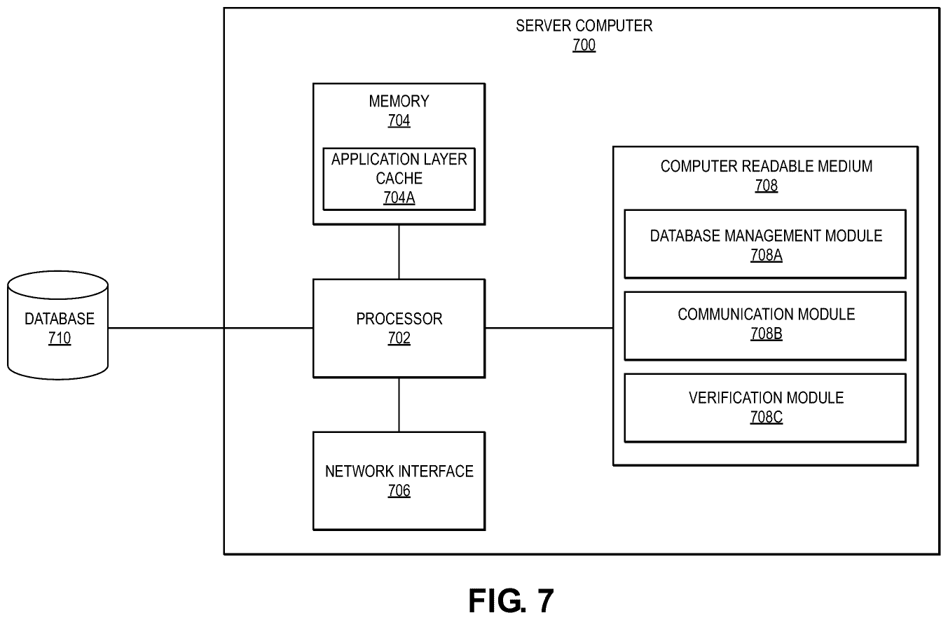

FIG. 7 shows a block diagram of a server computer 700 according to embodiments. The server computer 700 may facilitate the use of an alias. For example, the server computer 700 may resolve an alias to an account identifier that was linked during the registration of the alias. The server computer 700 may store a plurality of aliases. The server computer 700 may comprise a processor 702. The processor 702 may be coupled to a memory 704, a network interface 706, a computer readable medium 708, and a database 710. The computer readable medium 708 may comprise any suitable number and types of software modules. The memory 704 may comprise an application layer cache 704A.

The memory 704 can be used to store data and code. In some embodiments, the memory 704 may be linked to a database 710. The memory 704 and/or the database 710 may be coupled to the processor 702 internally or externally (e.g., via cloud-based data storage), and may comprise any combination of volatile and/or non-volatile memory such as RAM, DRAM, ROM, flash, or any other suitable memory device. The memory may comprise an application layer cache 704A which stores data for rapid retrieval. The database 710 may store aliases and access data for a plurality of transfer applications. In some embodiments, the server computer 700 may store the data items (e.g., an alias, the account identifier and/or token, etc.) received as a result of issuing an alias in the database 710.

The network interface 706 may include an interface that can allow the server computer 700 to communicate with external computers. The network interface 706 may have the same features or different features as the previously described network interface 606.

The computer readable medium 708 may comprise code, executable by the processor 702, for a method comprising: receiving, from a user device comprising a transfer application via a communications network, contact data for a plurality of potential receivers on the user device; searching a database for a set of aliases associated with the potential receivers in the contact data; and providing, via the communications network, the set of aliases to the user device, wherein the user device is programmed to store the set of aliases in the transfer application, receive a selection of an alias associated with a receiver, and initiate an interaction with the alias using the transfer application.

The computer readable medium 708 may comprise several software modules including, but not limited to, a database management module 708A, a communication module 708B, and a verification module 708C.

The database management module 708A may comprise code that causes the processor 702 to manage data stored by the memory 704 and/or the database 710. For example, during issuance of an alias, the database management module 708A may allow the processor 702 to verify the uniqueness of a received alias to a plurality of aliases stored in the database 710. In some embodiments, after the server computer 700 receives a payload, the database management module 708A may retrieve the account identifier or token linked to an issued alias included in the payload.

The communication module 708B may comprise code that causes the processor 702 to generate messages, forward messages, receive message, reformat messages, and/or otherwise communicate with other entities. For example, the communication module 708B may allow the processor 702 to receive a request to check the uniqueness of an alias from an authorizing entity computer or a user device and generate a response.

The verification module 708C may comprise code that causes the processor 702 to verify whether the alias received from a user device 600 exist in its database. For example, a first user device can send a receiver alias to conduct a transfer transaction (e.g., sending money). The server computer 700 can use the verification module 708C to verify whether the receiver alias exists in the database 710. The verification module 708C can also obtain other data stored in the database 710 that links to the receiver alias, such as a credential (e.g., a primary account number), a device identifier number (e.g., a mobile phone number), etc.

FIG. 8 shows additional screenshots of a user interface which can allow a sender to verify that they are sending funds to the correct receiver. As shown in screenshot 802, an image may be shown to the user to enter the receiver's phone number or a portion thereof into input data fields. In screenshot 804, the sender can enter the last four digits of the receiver's phone number into the input data fields. In screenshot 806, an image of the receiver 806A and a value to transfer to the receiver are shown. In screenshot 808, an image of a completion screen is shown.

Embodiments of the enable a faster retrieval of search results, aliases are obtained from a user's contact data on their user device. The user need not search of the database every time the sender wants to locate an alias in embodiments of the invention. This saves time and computing resources, and is more convenient for a user seeking to conduct an interaction with another user. Moreover, the sender does not need to not know the full receiver alias and the sender may instead select from the a list of known contacts to identify an appropriate alias. As a result, errors involving incorrect receiver aliases are reduced and the user experience is enhanced.

Any of the software components or functions described in this application, may be implemented as software code to be executed by a processor using any suitable computer language such as, for example, Java, C++, or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention may become apparent to those skilled in the art upon review of the disclosure. The scope of the invention can, therefore, be determined not with reference to the above description, but instead can be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
receiving, by a server computer from a user device comprising a transfer application via a communications network, contact data for a plurality of potential users on the user device;
searching, by the server computer a database, for a set of aliases associated with the potential users in the contact data; and
providing, by the server computer via the communications network, the set of aliases to the user device, wherein the user device is programmed to store the set of aliases in the transfer application, receive a selection of an alias associated with a user, and initiate an interaction with the alias using the transfer application.

2. The method of claim 1, wherein the contact data comprises phone numbers and/or e-mail addresses of users.

3. The method of claim 1, wherein the user device is a mobile phone.

4. The method of claim 3, wherein the interaction utilizes an OCT message.

5. The method of claim 1, wherein the user device comprises a data storage application and the contact data is stored in the data storage application.

6. The method of claim 1, wherein the transfer application is in communication with and is supported by the transfer application.

7. The method of claim 1, wherein the interaction provides a value to a user record associated with the alias.

8. The method of claim 7, wherein the transfer application is a first transfer application, the user is a receiver user, and the receiver user has a receiver user device comprising a second transfer application that is supported by a second transfer application server.

9. The method of claim 1, wherein the database stores a plurality of aliases associated with a plurality of different transfer application servers.

10. The method of claim 9, wherein the database stores the plurality of aliases in association with access data of users.

11. The method of claim 10, wherein the access data of the users comprises credentials, tokenized credentials, virtual credentials, or tokenized virtual credentials.

12. A server computer comprising:
a processor; and
a computer readable medium, the computer readable medium comprising code, executable by the processor for performing a method comprising:
receiving, from a user device comprising a transfer application via a communications network, contact data for a plurality of potential users on the user device;
searching a database for a set of aliases associated with the potential users in the contact data; and
providing, via the communications network, the set of aliases to the user device, wherein the user device is programmed to store the set of aliases in the transfer application, receive a selection of an alias associated with a user, and initiate an interaction with the alias using the transfer application.

13. The server computer of claim 10, wherein the contact data comprises a phone number and/or e-mail of users.

14. The server computer of claim 10, wherein the database stores a plurality of aliases associated user records managed by a plurality of different transfer application servers.

15. The server computer of claim 10, wherein the database stores the plurality of aliases in association access data.

16. A method comprising:
transmitting, by a user device comprising a transfer application to a server computer via a communications network, contact data for a plurality of potential users on the user device, wherein the server computer searches a database, for a set of aliases associated with the potential users in the contact data; and
receiving, by user device from the server computer via the communications network, the set of aliases;
storing, by the user device, the set of aliases in the transfer application; and
receiving, by the user device, a selection of an alias associated with a user; and
initiating, by the user device, an interaction with the alias using the transfer application.

17. The method of claim 16, wherein the user is a first user, and the method further comprises:
requesting, by the transfer application on the user device, consent of the first user operating the user device to send the contact data to the server computer; and
receiving, by the transfer application on the user device, the consent from the first user.

18. The method of claim 16, wherein the user device is a mobile phone.

19. The method of claim 16, wherein the contact data comprises a phone number and/or e-mail of users.

20. The method of claim 16, wherein the interaction involves a communication to a transfer application server associated with the transfer application, the communication comprising the alias and a value to transfer to a user record associated with the alias.
